(19) United States
(12) Patent Application Publication
(10) Pub. No.: US 2025/0048243 A1
(43) Pub. Date: Feb. 6, 2025

(54) METHOD AND APPARATUS FOR SUPPORTING USE OF LIGHTWEIGHT HETEROGENEOUS NETWORKS IN WIRELESS COMMUNICATION SYSTEM

(71) Applicant: Samsung Electronics Co., Ltd., Suwon-si (KR)

(72) Inventors: Dongeun SUH, Suwon-si (KR); Youngkyo BAEK, Suwon-si (KR)

(21) Appl. No.: 18/790,109

(22) Filed: Jul. 31, 2024

(30) Foreign Application Priority Data
Aug. 1, 2023 (KR) 10-2023-0100322

(51) Int. Cl. H04W 48/18; H04W 28/08; H04W 28/16

(52) U.S. Cl. CPC H04W 48/18; H04W 28/0925; H04W 28/16

(57) ABSTRACT

The disclosure relates to a fifth generation (5G) or a sixth generation (6G) communication system for supporting a higher data transmission rate. A method and an apparatus for supporting the use of lightweight heterogeneous networks in a wireless communication system are provided.

### CROSS-REFERENCE TO RELATED APPLICATION(S)

This application is based on and claims priority under 35 U.S.C. § 119 (a) of a Korean patent application number 10-2023-0100322, filed on Aug. 1, 2023, in the Korean Intellectual Property Office, the disclosure of which is incorporated by reference herein in its entirety.

### BACKGROUND

### 1. Field

The disclosure relates to a method and an apparatus for supporting the use of lightweight heterogenous networks in a wireless communication system.

### 2. Description of Related Art

Fifth generation (5G) mobile communication technologies define broad frequency bands to enable high transmission rates and new services, and can be implemented not only in “Sub 6 GHz” bands, such as 3.5 GHZ, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced mobile broadband (eMBB), ultra reliable & low latency communications (URLLC), and massive machine-type communications (mMTC), there has been ongoing standardization regarding beamforming and massive multiple-input multiple-output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), or the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for securing coverage in terahertz bands of 6G mobile communication technologies, full dimensional MIMO (FD-MIMO), multi-antenna transmission technologies, such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method of providing a service through non-third generation partnership project (3GPP) access without separate equipment for control signaling and traffic processing.

Another aspect of the disclosure is to provide a method of performing control to enable transmission and reception of specific application traffic through native non-3GPP access (which provides only Internet protocol (IP) connectivity unlike non-3GPP access provided through separate equipment).

Another aspect of the disclosure is to provide a method of receiving information for using non-3GPP access by a UE through 3GPP access of the UE.

Another aspect of the disclosure is to provide a method capable of using non-3GPP access (for example, Institute of Electrical and Electronics Engineers (IEEE) wireless local area network (WLAN)) without any separate connection to non-3GPP access for controlling non-3GPP access of the UE.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes transmitting, to an access and mobility management function (AMF), a first message for requesting an establishment of a protocol data unit (PDU) session, the first message including at least one of information indicating whether the PDU session is for a type of a non-3GPP access or information indicating whether the terminal supports the type of the non-3GPP access, and receiving, from a session management function (SMF), a second message for accepting the establishment of the PDU session, the second message including information on an external proxy address for the type of the non-3GPP access, wherein the type of the non-3GPP access network provides direct Internet protocol (IP) connection to the terminal without any intermediate network function.

In an embodiment of the disclosure, a policy indicating which traffic is subject to the type of the non-3GPP access is indicated to the terminal by a policy control function (PCF).

In an embodiment of the disclosure, the first message is transmitted based on the policy.

In an embodiment of the disclosure, the information indicating whether the PDU session is for the type of the non-3GPP access includes information indicating the PDU session is for a multi access (MA) PDU session.

In an embodiment of the disclosure, the information on the external proxy address includes at least one of IP address or port number.

In an embodiment of the disclosure, wherein information for identifying the terminal for the type of the non-3GPP access is used to transmit a traffic for the type of the non-3GPP access.

In accordance with another aspect of the disclosure, a method performed by a session management function (SMF) in a communication system is provided. The method includes receiving, from a terminal, a first message for requesting an establishment of a protocol data unit (PDU) session, the first message including at least one of information indicating whether the PDU session is for a type of a non-3GPP access or information indicating whether the terminal supports the type of the non-3GPP access, transmitting, to a user plane function (UPF) supporting the type of the non-3GPP access, a second message for requesting information on an external proxy address for the type of the non-3GPP access, receiving, from the UPF, a third message including the information on the external proxy address for the type of the non-3GPP access, and transmitting, to the terminal, a fourth message for accepting the establishment of the PDU session, the fourth message including the information on the external proxy address for the type of the non-3GPP access, wherein the type of the non-3GPP access network provides direct Internet protocol (IP) connection to the terminal without any intermediate network function.

In an embodiment of the disclosure, the first message is received based on a policy indicating which traffic is subject to the type of the non-3GPP access configured by policy control function (PCF).

In an embodiment of the disclosure, the information indicating whether the PDU session is for the type of the non-3GPP access includes information indicating the PDU session is for a multi access (MA) PDU session.

In an embodiment of the disclosure, the information on the external proxy address includes at least one of IP address or port number.

In an embodiment of the disclosure, selecting the UPF supporting the type of the non-3GPP access.

In an embodiment of the disclosure, the UPF is selected based on information retrieved from a network repository function (NRF).

In accordance with another aspect of the disclosure, a terminal in a wireless communication system is provided. The terminal includes a transceiver, and a controller configured to transmit, to an access and mobility management function (AMF) via the transceiver, a first message for requesting an establishment of a protocol data unit (PDU) session, the first message including at least one of information indicating whether the PDU session is for a type of a non-3GPP access or information indicating whether the terminal supports the type of the non-3GPP access, and receive, from a session management function (SMF) via the transceiver, a second message for accepting the establishment of the PDU session, the second message including information on an external proxy address for the type of the non-3GPP access, wherein the type of the non-3GPP access network provides direct Internet protocol (IP) connection to the terminal without any intermediate network function.

In accordance with another aspect of the disclosure, a session management function (SMF) in a communication system is provided. The SMF includes a transceiver, and a controller configured to receive, from a terminal via the transceiver, a first message for requesting an establishment of a protocol data unit (PDU) session, the first message including at least one of information indicating whether the PDU session is for a type of a non-3GPP access or information indicating whether the terminal supports the type of the non-3GPP access, transmit, to a user plane function (UPF) supporting the type of the non-3GPP access via the transceiver, a second message for requesting information on an external proxy address for the type of the non-3GPP access, receive, from the UPF via the transceiver, a third message including the information on the external proxy address for the type of the non-3GPP access, and transmit, to the terminal via the transceiver, a fourth message for accepting the establishment of the PDU session, the fourth message including the information on the external proxy address for the type of the non-3GPP access, wherein the type of the non-3GPP access network provides direct Internet protocol (IP) connection to the terminal without any intermediate network function.

A method of providing a service through non-3GPP access without separate equipment for control signaling and traffic processing is provided.

A method of performing control to transmit and receive specific application traffic through native non-3GPP access (that is, non-3GPP access providing only Internet protocol (IP) connectivity unlike non-3GPP access provided through separate equipment) is provided.

A method of receiving information for using non-3GPP access of the UE through 3GPP access of the UE. The disclosure may provide a method capable of using non-3GPP access (for example, IEEE WLAN) without any separate connection to non-3GPP access for controlling non-3GPP access of the UE is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a fifth generation (5G) system architecture according to an embodiment of the disclosure;

FIG. 2 illustrates a method of transmitting, to a user equipment (UE), rule information indicating whether to transmit traffic of the UE through access during a UE registration procedure according to an embodiment of the disclosure;

FIG. 3 illustrates a procedure in which a policy control function (PCF) updates a UE policy considering native non-third generation partnership project (3GPP) access according to an embodiment of the disclosure;

FIG. 4 illustrates a protocol data unit (PDU) session create procedure according to an embodiment of the disclosure;

FIG. 5 illustrates a configuration of a UE according to an embodiment of the disclosure; and

FIG. 6 illustrates a configuration of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card.

In the following description, a base station is an entity that allocates resources to terminals, and may be at least one of a Node B, a base station (BS), an eNode B (eNB), a gNode B (gNB), a wireless access unit, a base station controller, and a node on a network. A terminal may include a user equipment (UE), a mobile station (MS), a cellular phone, a smartphone, a computer, or a multimedia system capable of performing a communication function. Furthermore, the embodiments of the disclosure as described below may also be applied to other communication systems having similar technical backgrounds or channel types to the embodiments of the disclosure. In addition, based on determinations by those skilled in the art, the embodiments of the disclosure may be applied to other communication systems through some modifications without significantly departing from the scope of the disclosure. Examples of such communication systems may include 5th generation mobile communication technologies (5G, new radio, and NR) developed beyond long term evolution advanced (LTE-A), and in the following description, the “5G” may be the concept that covers the exiting long term evolution (LTE), LTE-A, and other similar services. In addition, based on determinations by those skilled in the art, the disclosure may also be applied to other communication systems through some modifications without significantly departing from the scope of the disclosure.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, some of terms and names defined in the 3rd generation partnership project (3GPP) long term evolution (LTE) standards and/or 3GPP new radio (NR) standards may be used for the sake of descriptive convenience. However, the disclosure is not limited by these terms and names, and may be applied in the same way to systems that conform other standards.

In a mobile communication system, a user equipment (UE) may receive a service through non-3GPP access (for example, wireless LAN) as well as through 3GPP access (for example, radio access technology, such as 3GPP new radio). In the related art, the UE could receive a service provided by a mobile communication system through only non-3GPP access that can be connected to separate equipment (for example, a non-3GPP interworking function, a N3IWF, a TNGF, or the like) for mobility management, session management, and the like for non-3GPP access.

Meanwhile, the disclosure proposes a method of providing a service through non-3GPP access without separate control connection for non-3GPP access and separate equipment therefor. In the disclosure, non-3GPP access that does not require mobility management or non-3GPP access that provides a service through separate equipment without any control plane/data plane connection (that is, N2 and N3) is referred to as native non-3GPP access.

Further, a method capable of transmitting and receiving specific application traffic through native non-3GPP access (that is, non-3GPP access providing only IP connectivity unlike non-3GPP access provided through separate equipment) is proposed.

A 5G mobile communication network includes a 5G user equipment (UE or terminal), a 5G radio access network (RAN, base station, 5g nodeB (gNB), evolved nodeB (eNB), or the like), and a 5G core network. The 5G core network may include network functions, such as an access and mobility management function (AMF) for providing a mobility management function of the UE, a session management function (SMF) for providing a session management function, a user plane function (UPF) serving to transmit data, a policy control function (PCF) for providing a policy control function, a unified data management (UDM) for providing a function of managing data, like subscriber data and policy control data, or a unified data repository (UDR) for storing data of various network functions, such as the UDM.

In the 5G system, a network slicing technology indicates a technology and structure that enable a plurality of independent logical networks which are virtualized in one physical network. A network operator configures a virtual end-to-end network that is a network slice and provides a service in order to meet specialized requirements of the service/application. The network slice is divided into identifiers corresponding to single-network slice selection assistance information (S-NSSAI), and the network operator provides network slice(s) to the UE so that the UE receives the service.

Specifically, in the 5G system, when registering a network, the UE may transmit, to the AMF, identifier (ID) information (that is, requested S-NSSAIs) for network slices for which the UE desires to make a request, and the AMF may provide the UE with the information on the network slices (allowed NSSAI) that can be used by the UE based on requested S-NSSAIs, subscriber information, and the like. Although the UE does not provide the AMF with the requested information on the slices, the AMF may provide the UE with the allowed NSSAI, in which case the allowed NSSAI may include information on default configured NASSI and information on slices configured by default (that is, default subscribed S-NSSAIs) among subscribed slices included in UE subscriber information.

When any slice cannot be included in the allowed NSSAI (for example, there is no default configured NSSAI and default subscribed S-NSSAIs or they cannot be used), the AMF may transmit a network registration rejection message including a cause code indicating registration rejection due to no available slice to the UE.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

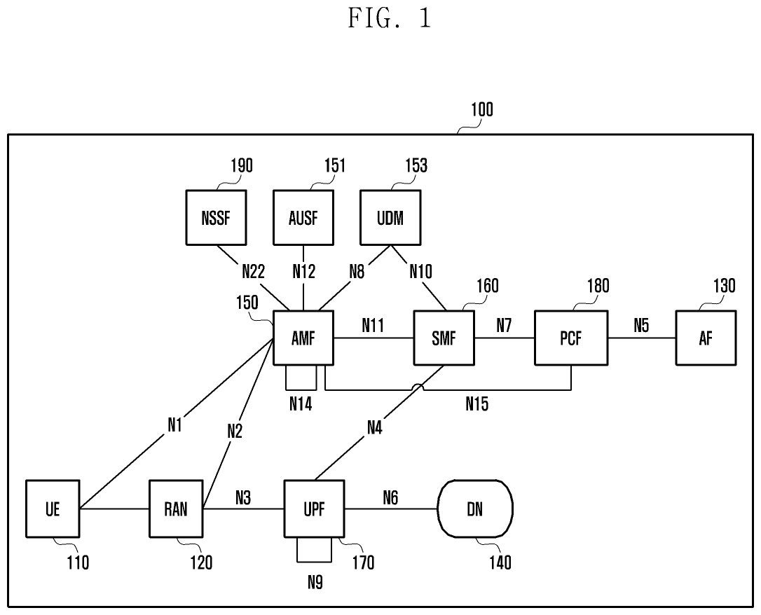

FIG. 1 illustrates a 5G system architecture 100 according to an embodiment of the disclosure.

Referring to FIG. 1, in the 3GPP system, a conceptual link connecting NFs within the 5G system is defined as a reference point. Reference points included in the 5G system architecture of FIG. 1 are described below. The 5G system architecture 100 may include a network slice selection function (NSSF) 190, an AUSF 151, a UDM 153, an AMF 150, a SMF 160, a UPF 170, a PCF 180, a UDM, a UDR, an NRF, an application function (AF) 130, a UE 110, a RAN 120, and a DN 140, and the like.
N1: reference point between the UE 110 and the AMF 150
N2: reference point between the (R)AN 120 and the AMF 150
N3: reference point between the (R)AN 120 and the UPF 170
N4: reference point between the SMF 160 and the UPF 170
N5: reference point between the PCF 180 and the AF 130
N6: reference point between the UPF 170 and the data network (DN)
N7: reference point between the SMF 160 and the PCF 180
N8: reference point between the UDM 153 and the AMF 150
N9: reference point between two core UPFs 170
N10: reference point between the UDM 153 and the SMF 160
N11: reference point between the AMF 150 and the SMF 160
N12: reference point between the AMF 150 and the authentication server function (AUSF) 151
N 13: reference point between the UDM 153 and the authentication server function (AUSF) 151
N14: reference point between two AMFs 150
N15: reference point between the PCF 180 and the AMF 150 in non-roaming scenario and reference point between the PCF 180 and the AMF 150 within a visited network in roaming scenario

The disclosure proposes a method of providing a service through non-3GPP access without separate equipment for control signaling and traffic processing.

The disclosure proposes a method of performing control to transmit and receive specific application traffic through native non-3GPP access (that is, non-3GPP access providing only Internet protocol (IP) connectivity unlike non-3GPP access provided through separate equipment).

The disclosure proposes a method of receiving information for using non-3GPP access by a UE through 3GPP access by the UE. The disclosure proposes a method capable of using non-3GPP access (for example, IEEE WLAN) without any connection to non-3GPP access for controlling non-3GPP access of the UE.

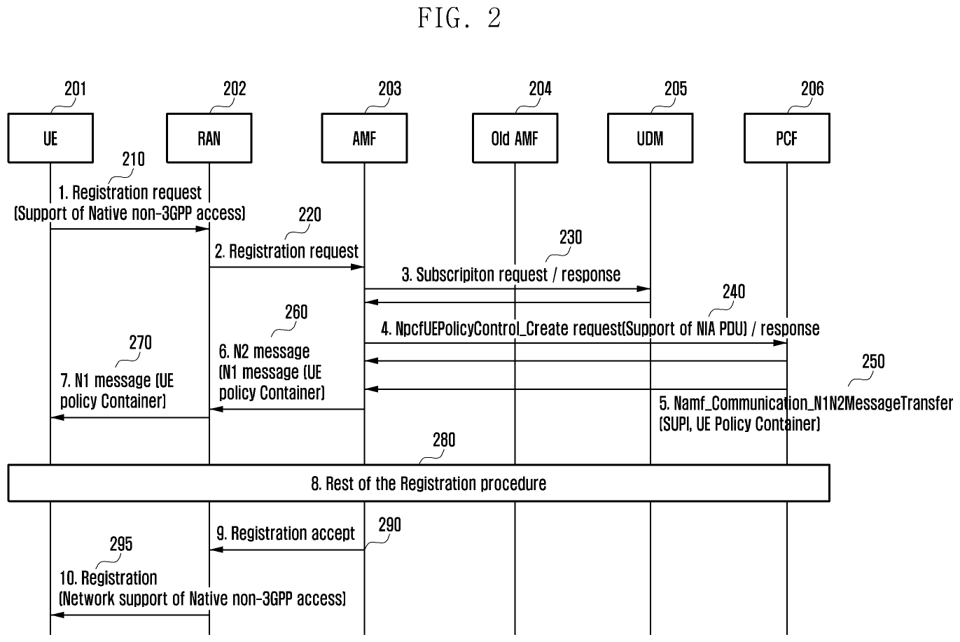

FIG. 2 illustrates a method of transmitting, to a UE, rule information indicating whether to transmit traffic of the UE through access during a UE registration procedure according to an embodiment of the disclosure.

Referring to FIG. 2, in operation 210, a UE 201 may transmit a message (AN parameter or registration request) to a RAN 202. At this time, the registration request message may include at least one of a UE identifier (subscription concealed identifier (SUCI), a 5G-globally unique temporary identity (5G-GUTI), a permanent equipment identifier (PEI), or the like), requested NSSAI, UE mobility management (MM) core network capability, and the like. When the UE 201 supports native non-3GPP access, the UE 201 may insert information indicating supporting of the native non-3GPP access, for example, support of native non-3GPP access into the UE MM core network capability.

For example, when receiving, through 3GPP access, an external proxy (for example, an MPTCP proxy, an MPQUIC proxy, or a QUIC proxy) address through non-3GPP access, the UE 201 supporting the native non-3GPP access may make a connection to the corresponding external proxy and transmit application traffic. Further, the UE 201 supporting the native non-3GPP access may provide the external proxy with information that the external proxy can use for authentication of the UE 201 during the procedure of making the connection with the external proxy.

In operation 220, the RAN 202 may select an AMF 203, based on information within the AN message received from the UE 201. The RAN 202 may transmit a N2 message (N2 parameters or registration request) to the selected AMF 203. The N2 parameter may include a selected PLMN ID, UE location information, a UE context request, and the like. At this time, the N2 message may include a RAN ID.

In operation 230, steps required for the UE registration procedure may be performed. According to an embodiment of the disclosure, when the 5G MM core network capability provided by the UE 201 in operation 210 includes the support of native non-3GPP access, the AMF 203 may store the corresponding information in UE context information for the UE 201. Further, when the AMF 203 has no UE context for the UE 201, the AMF 203 may determine a previous AMF (old AMF) 204 of the UE 201, based on the 5G-GUTI received in operation 210, transmit a UE context request message including an identifier of the UE 201 to the old AMF 204, and receive UE context for the UE 201 from the old AMF 204 in response thereto. The UE context that the AMF 203 received may include the support of native non-3GPP access.

According to an embodiment of the disclosure, the UE context request message which the new AMF 203 transmits to the old AMF 204 may include information indicating whether to support a PDU session through native non-3GPP access of the new AMF 203. When the old AMF 204 knows that the new AMF 203 does not support the PDU Session through native non-3GPP access, the old AMF 204 may release the PDU session through the native non-3GPP access or release user plane resources corresponding to the native non-3GPP access.

In operation 230, the AMF 203 may make a request for subscription information of the UE 201 and receive the same from the UDM 205. According to an embodiment of the disclosure, the AMF 203 may transmit a subscription request message to the UDM 205 to make a request for subscription information of the UE 201. Further, the UDM 205 may transmit a subscription response message to the AMF 203 to transmit subscription information of the UE 201. According to an embodiment of the disclosure, the subscription information of the UE 201 which the AMF 203 received from the UDM 205 may include information indicating whether the UE 201 can use the native non-3GPP access. When the subscription information received from the UDM 205 includes information indicating that the native non-3GPP access can be used, the AMF 203 may perform operation 240. When the native non-3GPP access cannot be used (for example, when there is no information indicating that the native non-3GPP access can be used in the subscription information or when the subscription information includes information indicating the native non-3GPP access cannot be used), the AMF 203 may not transmit information indicating that the native non-3GPP access is supported to the PCF 206 in operation 240. Further, information indicating that the native non-3GPP access is supported may not be included in a registration accept (or registration reject) message transmitted to the UE 201 in operation 295.

In operation 240, the AMF 203 may transmit a policy information create or update request for the UE 201 to the PCF 206. The corresponding information may include a UE ID (for example, SUPI) and information on whether the UE 201 supports the native non-3GPP access. According to an embodiment of the disclosure, the message which the AMF 203 transmits to the PCF 206 may be a NpcfUEPolicyControl_Create request message. According to an embodiment of the disclosure, the information on whether the UE 201 supports the native non-3GPP access may be indicated as information, such as information on support of a non-integrated aggregated (NIA) PDU session or information on support of a multi-access (MA) PDU session.

When the PCF 206 receives the policy information create or update request for the UE 201 from the AMF 203 in operation 240, the PCF 206 may insert a UE policy container containing information (for example, UE route selection policy (URSP) rule(s)) indicating which UE traffic will be transmitted through native non-3GPP access into a N1 message (that is, a message transmitted to the UE 201) of a message transmitted to the AMF 203 in operation 250. The message may include the identifier of the UE 201, for example, a SUPI. The PCF 206 may transmit the N1 message to the AMF 203. According to an embodiment of the disclosure, the N1 message may be included in a NpcfUEPolicyControl_Create response message or a Namf_Communication_NIN2MessageTransfer message. The UE 201 may determine to transmit/receive traffic through a PDU session that can use the native non-3GPP access, based on URSP rule(s) considering the native non-3GPP access (that is, an access type that does not pass through the N3IWF). Specifically, the URSP rule is a rule indicating which path is used to transmit application traffic of the UE 201 and may be configured by the following information.

### Rule Precedence, Traffic Descriptor (TD), a List of Route Selection Description (RSD)

The TD may include an IP descriptor (for example, a source IP address, a source port number, a destination IP address, a destination port number, a protocol type, and the like), and connection capability (that may include information provided when a UE application makes a request for the connection to transmit traffic, for example, a traffic category. For example, gaming traffic, enterprise traffic, and the like), an app id (for example, an identifier for an application), a data network name (DNN) (that may include a data network name, for example, a DNN for the Internet, a DNN for a phone service, and the like), and the like.

According to an embodiment of the disclosure, the RSD may include one or more pieces of the following information.

### Access Preference:

indicates which access types is used to transmit UE traffic. It may have one of the following values.
3GPP access, non-3GPP access, native non-3GPP access, both 3GPP access and native non-3GPP access, both 3GPP access and non-3GPP access, both non-3GPP access and native non-3GPP access

Further, the RSD within each URSP rule generated by the PCF 206 may include an RSD precedence value, a single network slice selection preference, a DNN selection, a session service continuity (SSC) mode selection, and the like as well as the above-mentioned information.

When the message received from the PCF 206 includes the N1 message in operation 260, the AMF 203 may insert the information included in the corresponding message into a N2 message transmitted to the RAN 202 (for example, insert the N1 message into a N2 message). At this time, the N1 message may include UE policy container information included in the message received from the PCF 206. The AMF 203 may transmit the N2 message to the RAN 202.

When the N2 message received from the AMF 203 includes the N1 message, the RAN 202 may transmit the N1 message to the UE 201 in operation 270. The N1 message may include UE policy container information.

In operation 280, the UE 201 and network entities 202, 203, 205, 206, and the like may perform the remaining registration procedures. A detailed operation therefor may follow the content specified in the 3GPP standard without departing from the scope of the disclosure, and a detailed description thereof is omitted. In the case of the registration procedure in operation 280, it can be easily inferred and interpreted by those skilled in the art.

In operation 290 and operation 295, the AMF 203 may transmit a registration accept message transmitted to the UE 201 through the RAN 202. The registration accept message may include information indicating that the network supports traffic transmission through native non-3GPP access.

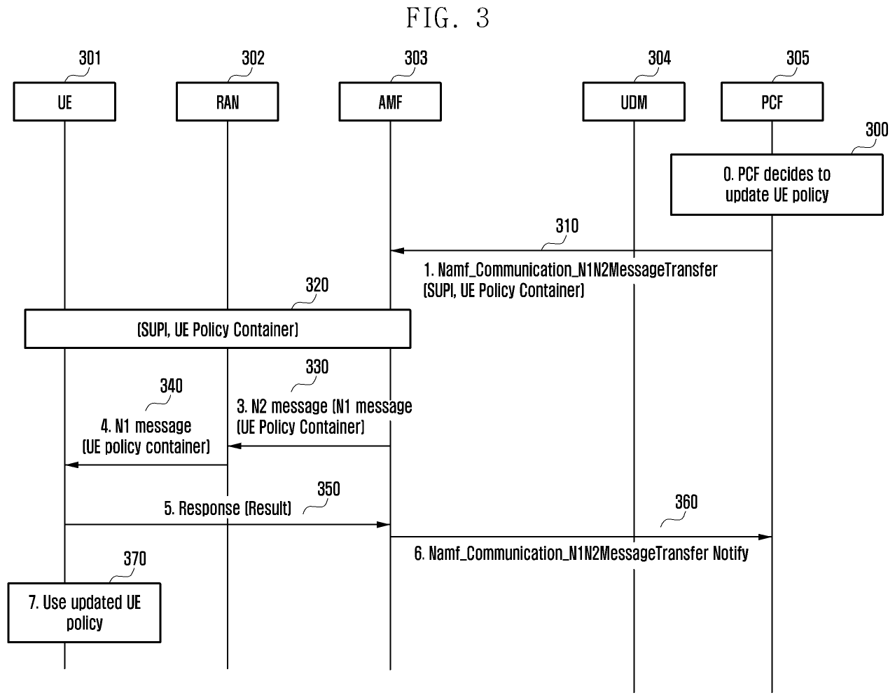

FIG. 3 illustrates a procedure in which a PCF updates a UE policy considering native non-3GPP access according to an embodiment of the disclosure.

Referring to FIG. 3, in operation 300, a PCF 305 may determine that a UE policy needs to be updated during an initial registration procedure or the like. When the UE policy update is a policy update related to native non-3GPP access, the PCF 305 may perform the UE policy update only for UEs 301 which can use the native non-3GPP access, based on whether the native non-3GPP access included in subscription information of the UE 301 is supported or whether the UE 301 supports the native non-3GPP access according to an embodiment.

When the PCF 305 determines that one or more URSP rules included in the UE policy need to be updated, the PCF 305 may determine a UE policy including new URSP rule(s) and start a procedure for transferring the same to the UE 301. The URSP rule is a rule indicating which path is used to transmit application traffic of the UE 301 and may be configured to include the following information.

The PCF 305 may insert a UE policy container containing URSP rule(s) into the N1 message transmitted to the AMF 303. The URSP rule may include a rule indicating which traffic the native non-3GPP access is to be used for, and the UE 301 may determine transmission/reception of specific traffic through native non-3GPP access, based on the URSP rule. Specifically, the URSP rule is a rule indicating which path is used to transmit application traffic of the UE 301 and may be configured including at least one piece of the following information.

### Rule Precedence, Traffic Descriptor (TD), a List of Route Selection Description (RSD)

The TD may include an IP descriptor (for example, a source IP address, a source port number, a destination IP address, a destination port number, a protocol type, and the like), and connection capability (that may include, for example, information provided when a UE application makes a request for the connection to transmit traffic, for example, a traffic category. For example, gaming traffic, enterprise traffic, and the like), an app id (for example, an identifier for an application), a data network name (DNN) (that may include a data network name, for example, a DNN for the Internet, a DNN for a phone service, and the like), and the like.

According to an embodiment of the disclosure, the RSD may include one or more pieces of the following information:

### Access Preference:

It indicates which access type is used to transmit UE traffic. It may have one of the following values.

### 3GPP Access, Non-3GPP Access, Native Non-3GPP Access, Both 3GPP Access and Native Non-3GPP Access, Both 3GPP Access and Non-3GPP Access, Both Non-3GPP Access and Native Non-3GPP Access

Further, the RSD within each URSP rule generated by the PCF 305 may include an RSD precedence value, a single network slice selection preference, a DNN selection, a session service continuity (SSC) mode selection, and the like as well as the above-mentioned information.

In operation 310, the PCF 305 may transmit a message to the UDM 304 for updating the UE policy according to the determination in operation 300 to the AMF 303. At this time, the information that the PCF 305 transmits to the AMF 303 may include a UE policy container including the UE policy in operation 300 and the identifier of the UE 301 (for example, SUPI). According to an embodiment of the disclosure, the message may be a Namf_Communication_NIN2MessageTransfer message.

When the UE 301 is in a CM-IDLE state (that is, the UE 301 has no control plane connection with the AMF 303) and is reachable in 3GPP access, the AMF 303 may transmit a paging message to the UE 301 in operation 320.

The UE 301 receiving the paging message may transmit a service request to the network and generate the control plane connection with the AMF 303.

When the UE 301 is in the CM-IDLE state, the AMF 303 may transmit a UE policy container to the UE 301 via the RAN 302 in operation 330 and operation 340. For example, in operation 330, the AMF 303 may transmit a N1 message containing the UE policy container to the RAN 302. Further, the AMF 303 may insert the N1 message into a N2 message and transmit the N2 message to the RAN 302.

In operation 340, the RAN 302 may transmit the UE policy container received from the AMF 303 to the UE 301. For example, when the RAN 302 receives the N2 message including the N1 message containing the U policy container from the AMF 303, the RAN 302 may transmit the N1 message to the UE 301. The N1 message may include the UE policy container. The UE 301 may update the UE policy, based on UE policy information contained in received the UE policy container.

In operation 350, the UE 301 may transmit a message including information indicating whether the UE policy is successfully updated in operation 340 to the AMF 303 via the RAN 302.

In operation 360, the AMF 303 may transmit the message including the information indicating whether the UE policy is successfully updated to the PCF 305, based on the information received in operation 350. According to an embodiment of the disclosure, the message transmitted to the PCF 305 may include information on success or failure of the UE policy update. According to an embodiment of the disclosure, when the UE policy update has failed, information on the reason for failure may be included in the message. According to an embodiment of the disclosure, the message may be a Namf_Communication_NIN2MessageTransfer Notify message.

When information indicating the use of native non-3GPP access for specific application traffic is included in the updated UE policy information, the UE 301 may determine to use traffic through the native non-3GPP access, based thereon in operation 370. According to an embodiment of the disclosure, the UE 301 may select a route, based on the URSP rule when application traffic is generated. For example, when application traffic is generated, the UE 301 may detect whether there is a traffic descriptor (TD) that matches information on application traffic from the URSP rule having a high precedence. When there is a matching TD, the UE 301 may select available RSDs.

The UE 301 may identify whether there is an available PDU session that satisfies all RSDs included in the selected RSDs. When there is no corresponding PDU session and an access preference corresponding to a TD that matches the generated traffic indicates native non-3GPP access, the UE 301 may identify whether the native non-3GPP access can be currently used. For example, it may be identified whether there is a connection with a native non-3GPP access point and whether Internet access is possible through the corresponding connection. When it is determined that the UE 301 can use the native non-3GPP access, the UE 301 may transmit a PDU session establishment request message to the AMF 303 (via the RAN 302) and insert a data transmission request indicator through native non-3GPP access into the corresponding message. The corresponding indicator may be transmitted in the form of a request type, in which case the request type may indicate a PDU session type (for example, a multi-access (MA) PDU session or a non-integrated aggregated (NIA) PDU session) corresponding to the PDU session through native non-3GPP access.

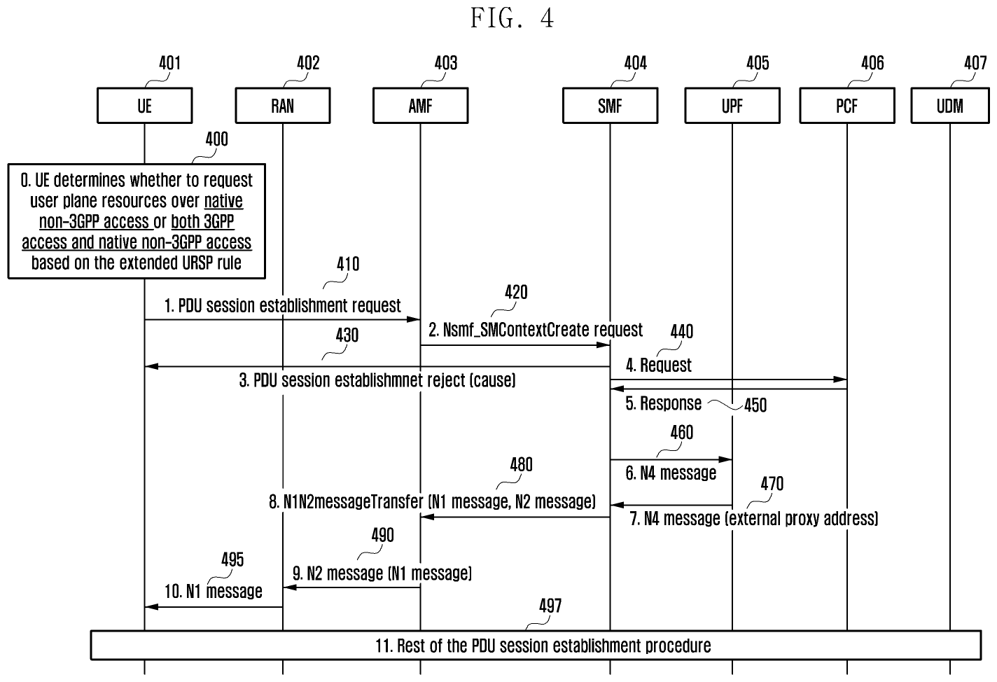

FIG. 4 illustrates a procedure of generating a PDU session according to an embodiment of the disclosure.

Referring to FIG. 4, in operation 400, a UE 401 may identify matching URSP rule(s) when traffic is generated. For example, based on the URSP rule(s), the UE 401 may determine whether to make a request for a user plane resource for native non-3GPP access or native non 3-GPP access and 3GPP access. When there is no PDU session that satisfies a route selection descriptor of the matching URSP rule(s), the UE 401 may determine information to be included in a PDU session generation establishment request message, based on the matching URSP rule. When the matching URSP rule indicates native non-3GPP access (or native non-3GPP access and 3GPP access), the UE 401 may insert a PDU session type (for example, may be referred to as various terms, such as a multi-access (MA) PDU session or a non-integrated aggregated (NIA) PDU session) that can use the native non-3GPP access into the PDU Session establishment request message.

In operation 410, the UE 401 may transmit a PDU session (generation/establishment) establishment request message to an AMF 403 via a RAN 402 (for example, PDU session establishment request message). At this time, when the matching URSP rule in operation 400 indicates native non-3GPP access (or native non-3GPP access and 3GPP access), information to be included in the PDU session establishment request message may be determined based on information included in the corresponding URSP rule. The corresponding message may include the following information.
PDU Session ID: Indicates a PDU Session Identifier.
Type: may include a NIA PDU session or a MA PDU session. The UE 401 may insert the corresponding information when the matching URSP rule in operation 400 indicates native non-3GPP access (or native non-3GPP access and 3GPP access).
Native non-3GPP access identification information: includes information for identifying the UE 401 that accesses through native non-3GPP access. This may include an IP address for the native non-3GPP access of the UE 401, a port number, token information for identifying the UE 401, and the like.
Session related capability: support of native non-3GPP access. The UE 401 may insert the corresponding information when the matching URSP rule in operation 400 indicates native non-3GPP access (or native non-3GPP access and 3GPP access).
S-NSSAI, DNN: indicates network slice identifier information and data network name information, respectively.

In operation 420, according to an embodiment of the disclosure, the AMF 403 may receive the PDU session establishment request message from the UE 401 and when the received PDU session establishment request message includes at least one of information indicating a PDU session type (for example, a MA PDU session, a NIA PDU session, or the like) that can use native non-3GPP access, a session-related capability indicating that the native non-3GPP access is supported, native non-3GPP access information, and the like, the AMF 403 may make a request for information on SMF(s) (for example, address information of SMF(s)) supporting the NIA PDU session or the MA PDU session to a network repository function (NRF) (not shown) and receive the information on the corresponding SMF(s) from the NRF (not shown). When the AMF 403 already knows the information on the SMF(s) supporting the NIA PDU session or the MA PDU session, the procedure may be omitted.

In operation 420, the AMF 403 may select the SMF 404 supporting the NIA PDU session or the MA PDU session and transmit a SM context create request message to the corresponding SMF 404. According to an embodiment of the disclosure, the SM context create request message may be a Nsmf_SMContextCreate request message.

The AMF 403 may insert one or more pieces of the following information into the message transmitted to the SMF 404.
PDU session ID, UE ID,
Information indicating native non-3GPP access. The corresponding information may be included in the form of access type.
It may include a NIA (or MA) PDU session indication, S-NSSAI, and a DNN.
Native non-3GPP access identification information

When the receiving the request message from the AMF 403, the SMF 404 may determine whether to allow the PDU session through the native non-3GPP access, based on subscription information of the UE 401 in operation 430. When an indicator that not allows the PDU session through the native non-3GPP access is included in the subscription information of the UE 401 (or an indicator that allows the PDU session through the native non-3GPP access is not included in the subscription information of the UE 401), the SMF 404 may transmit a PDU session establishment reject message (for example, a PDU session establishment rejection message) to the UE 401 via the AMF 403. The corresponding message may include information indicating that the native non-3GPP access is not allowed (for example, cause IE).

In operation 440, the SMF 404 may transmit a session policy create request message to the PCF 406. The corresponding message may include the following information.
PDU session ID
S-NSSAI, DNN
UE ID (for example, SUPI)
NIA PDU session indication or MA PDU session indication
Information indicating native non-3GPP access. The corresponding information may be included in the form of access type.
Native non-3GPP access identification information

When the message received by the PCF 406 in operation 440 includes information indicating a NIA PDU session indication or a MA PDU session indication and native non-3GPP access, the PCF 406 may insert the following information into a policy and charging control (PCC) rule indicating a policy rule for traffic within the session in operation 450.
Service data flow description: includes information indicating traffic to which a policy is applied. For example, at least one of an application id, an IP address/port number/protocol type, and the like may be included.
Steering Functionality: indicates protocol information used for traffic steering when native non-3GPP access and 3GPP access are simultaneously used. At least one of a MPTCP, a MPQUIC, and the like may be included.
Steering mode: indicates mode information used for traffic steering when native non-3GPP access and 3GPP access are simultaneously used. At least one of active/standby, aggregated, load balancing, best-quality access, redundant, and the like may be included.

In operation 450, the PCF 406 may transmit a message including the determined PCC rule(s) to the SMF 404.

In operation 460, the SMF 404 may determine a parameter for quality of service (QOS) flow, based on the PCC rule(s) received from the PCF 406. According to an embodiment of the disclosure, when the request message received in operation 420 includes at least one of information indicating a PDU session type (for example, a MA PDU session, a NIA PDU session, or the like) that can use native non-3GPP access, a session-related capability indicating that native non-3GPP access is supported, native non-3GPP access information, and the like, the SMF 404 may make a request for information on UPF(s) (for example, address information of the UPF(s)) supporting the NIA PDU session or the MA PDU session to the NRF (not shown) and receive (not shown) the information on the corresponding UPF(s) from the NRF. When the SMF 404 already knows the information on the UPF(s) supporting the NIA PDU session or the MA PDU session, the procedure may be omitted.

In operation 460, the SMF 404 may select the UPF 405 supporting the NIA PDU session or the MA PDU session and transmit a N4 message to the corresponding UPF 405. When the SMF 404 receives native non-3GPP access identification information from the AMF 403, the SMF 404 may insert a rule indicating that only traffic corresponding to identification information of the UE 401 included in the native non-3GPP access identification information is allowed into a N4 rule included in the N4 message transmitted to the UPF 405.

The SMF 404 may insert the following information into the message transmitted to the UPF 405.
N4 session ID, PDU session ID
N4 rule: includes information indicating which traffic an action will be taken for and which action will be taken for the traffic by the UPF. The corresponding information may include information indicating how the traffic is distributed to 3GPP access and native non-3GPP access.
NIA PDU session indication or MA PDU session indication
External proxy address request

In at least one of the cases where the NIA PDU session indication or the MA PDU session indication is included in the message received from the SMF 404, an external proxy address request is included therein, or the like, the UPF 405 may insert external proxy address information that can be accessed through native non-3GPP access into a message transmitted to the SMF 404 in operation 470. The corresponding information may be the form of an IP address/port number or a fully qualified domain name (FQDN). Further, the UPF 405 may transmit the N4 message including the external proxy address information that can be accessed through the native non-3GPP access to the SMF 404.

In operation 480, the SMF 404 may insert the following information into a message transmitted to the AMF 403.
N1 message: is a message transmitted to the UE 401, and may include a PDU session ID, an external proxy address, traffic distribution rule information between 3GPP and native non-3GPP access, QoS rule(s), and the like.
N2 message: is a message transmitted to the RAN 402, and may include a PDU session ID, QoS profile(s), and the like.
External proxy address

The SMF 404 may transmit a message (for example, N1N2messageTransfer) including the information to the AMF 403.

In operation 490, the AMF 403 may insert the N1 message received from the SMF 404 into the N2 message included in the message received from the SMF 404 and transmit the N2 message to the RAN 402. When the external proxy address is included in the message received from the SMF 404, the AMF 403 may store the same in information on the UE 401 (for example, UE context).

In operation 495, the RAN 402 may transmit the N1 message to the UE 401 and transmit information included in the N1 message to the UE 401.

When the external proxy address is included in the N1 message and an IP connection is made through non-3GPP access, the UE 401 may transmit a tunnel connection request message to the external proxy address. The corresponding request message may include information for identifying the UE 401 (For example, native non-3GPP access identification information in operation 410).

In operation 497, the UE 401 and network entities 402, 403, 404, 405, 406, 407, and the like may perform the remaining PDU session establishment procedures. A detailed operation therefor may follow the content specified in the 3GPP standard without departing from the scope of the disclosure, and a detailed description thereof is omitted.

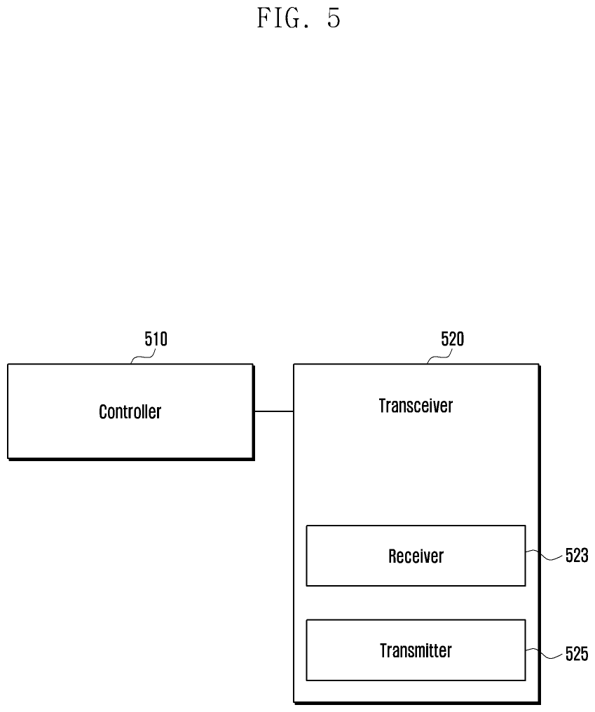

FIG. 5 illustrates a configuration of a UE according to an embodiment of the disclosure.

Referring to FIG. 5, the UE according to an embodiment of the disclosure may include a transceiver 520 and a controller 510 that controls the overall operation of the UE. The transceiver 520 may include a transmitter 525 and a receiver 523.

The transceiver 520 may transmit and receive signals to and from other network entities.

The controller 510 may control the UE to perform one operation in the above-described embodiments. Meanwhile, the controller 510 and the transceiver 520 do not have to be implemented as separated modules but may be implemented as one component, such as a single chip. The controller 510 and the transceiver 520 may be electrically connected. For example, the controller 510 may be a circuit, an application-specific circuit, or at least one processor. The operations of the UE may be implemented as memory device storing the corresponding program code is included in a predetermined component within the UE.

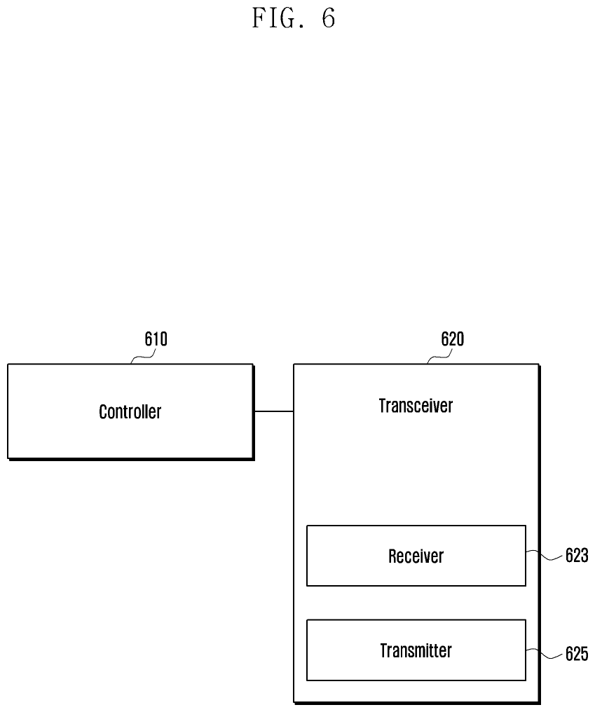

FIG. 6 illustrates a configuration of a network entity according to an embodiment of the disclosure.

The network entity according to the disclosure is a concept including a network function according to system implementation.

Referring to FIG. 6, the network entity according to an embodiment of the disclosure may include a transceiver 620 and a controller 610 that controls the overall operation of the network entity. The transceiver 620 may include a transmitter 625 and a receiver 623.

The transceiver 620 may transmit and receive signals to and from the UE and other network entities.

The controller 610 may control the network entity to perform one operation in the above-described embodiments. Meanwhile, the controller 610 and the transceiver 620 do not have to be implemented as separated modules but may be implemented as one component, such as a single chip. The controller 610 and the transceiver 620 may be electrically connected. For example, the controller 610 may be a circuit, an application-specific circuit, or at least one processor. Further, the operations of the network entity may be performed as memory device storing the corresponding program code is included in a predetermined component within the network entity.

The network entity may be one of a BS, an AMF, a SMF, a UPF, a PCF, a UDM, a UDR, an NRF, an application function (AF), a network slice selection function (NSSF) 190, an AUSF, a DN, and the like.

It should be noted that the configuration diagrams, illustrative diagrams of control/data signal transmission methods, illustrative diagrams of operation procedures, and structural diagrams as illustrated in FIGS. 1 to 6 are not intended to limit the scope of protection of the disclosure. For example, all the constituent units, entities, or operation steps shown in FIGS. 1 to 6 should not be construed as essential elements for implementing the disclosure, and even when including only some of the elements, the disclosure may be implemented without impairing the true nature of the disclosure.

The above-described operations of a base station or a terminal may be implemented by providing memory device storing corresponding program codes in a bast station or terminal device. For example, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits, such as complementary metal oxide semiconductor-based logic circuits, firmware, or hardware circuits, such as combinations of software and/or hardware and firmware and/or software embedded in a machine-readable medium. For example, various electrical structures and methods may be implemented using transistors, logic gates, and electrical circuits, such as application-specific integrated circuits.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
transmitting, to an access and mobility management function (AMF), a first message for requesting an establishment of a protocol data unit (PDU) session, the first message comprising at least one of information indicating whether the PDU session is for a type of a non-third generation partnership project (3GPP) access or information indicating whether the terminal supports the type of the non-3GPP access; and
receiving, from a session management function (SMF), a second message for accepting the establishment of the PDU session, the second message comprising information on an external proxy address for the type of the non-3GPP access,
wherein the type of the non-3GPP access network provides direct internet protocol (IP) connection to the terminal without any intermediate network function.

2. The method of claim 1,
wherein a policy indicating which traffic is subject to the type of the non-3GPP access is indicated to the terminal by a policy control function (PCF), and
wherein the first message is transmitted based on the policy.

3. The method of claim 1, wherein the information indicating whether the PDU session is for the type of the non-3GPP access comprises information indicating the PDU session is for a multi access (MA) PDU session.

4. The method of claim 1, wherein the information on the external proxy address comprises at least one of IP address or port number.

5. The method of claim 1, wherein information for identifying the terminal for the type of the non-3GPP access is used to transmit a traffic for the type of the non-3GPP access.

6. A method performed by a session management function (SMF) in a communication system, the method comprising:
receiving, from a terminal, a first message for requesting an establishment of a protocol data unit (PDU) session, the first message comprising at least one of information indicating whether the PDU session is for a type of a non-third generation partnership project (3GPP) access or information indicating whether the terminal supports the type of the non-3GPP access;
transmitting, to a user plane function (UPF) supporting the type of the non-3GPP access, a second message for requesting information on an external proxy address for the type of the non-3GPP access;
receiving, from the UPF, a third message comprising the information on the external proxy address for the type of the non-3GPP access; and
transmitting, to the terminal, a fourth message for accepting the establishment of the PDU session, the fourth message comprising the information on the external proxy address for the type of the non-3GPP access,
wherein the type of the non-3GPP access network provides direct internet protocol (IP) connection to the terminal without any intermediate network function.

7. The method of claim 6, wherein the first message is received based on a policy indicating which traffic is subject to the type of the non-3GPP access configured by policy control function (PCF).

8. The method of claim 6, wherein the information indicating whether the PDU session is for the type of the non-3GPP access comprises information indicating the PDU session is for a multi access (MA) PDU session.

9. The method of claim 6, wherein the information on the external proxy address comprises at least one of IP address or port number.

10. The method of claim 6,
wherein the transmitting the second message further comprises:
selecting the UPF supporting the type of the non-3GPP access, and
wherein the UPF is selected based on information retrieved from a network repository function (NRF).

11. A terminal in a wireless communication system, the terminal comprising:
a transceiver; and
a controller configured to:
transmit, to an access and mobility management function (AMF) via the transceiver, a first message for requesting an establishment of a protocol data unit (PDU) session, the first message comprising at least one of information indicating whether the PDU session is for a type of a non-third generation partnership project (3GPP) access or information indicating whether the terminal supports the type of the non-3GPP access, and
receive, from a session management function (SMF) via the transceiver, a second message for accepting the establishment of the PDU session, the second message comprising information on an external proxy address for the type of the non-3GPP access,
wherein the type of the non-3GPP access network provides direct internet protocol (IP) connection to the terminal without any intermediate network function.

12. The terminal of claim 11,
wherein a policy indicating which traffic is subject to the type of the non-3GPP access is indicated to the terminal by a policy control function (PCF), and
wherein the first message is transmitted based on the policy.

13. The terminal of claim 11, wherein the information indicating whether the PDU session is for the type of the non-3GPP access comprises information indicating the PDU session is for a multi access (MA) PDU session.

14. The terminal of claim 11, wherein the information on the external proxy address comprises at least one of IP address or port number.

15. The terminal of claim 11, wherein information for identifying the terminal for the type of the non-3GPP access is used to transmit a traffic for the type of the non-3GPP access.

16. A session management function (SMF) in a communication system, the SMF comprising:
a transceiver; and
a controller configured to:
receive, from a terminal via the transceiver, a first message for requesting an establishment of a protocol data unit (PDU) session, the first message comprising at least one of information indicating whether the PDU session is for a type of a non-third generation partnership project (3GPP) access or information indicating whether the terminal supports the type of the non-3GPP access,
transmit, to a user plane function (UPF) supporting the type of the non-3GPP access via the transceiver, a second message for requesting information on an external proxy address for the type of the non-3GPP access,
receive, from the UPF via the transceiver, a third message comprising the information on the external proxy address for the type of the non-3GPP access, and
transmit, to the terminal via the transceiver, a fourth message for accepting the establishment of the PDU session, the fourth message comprising the information on the external proxy address for the type of the non-3GPP access,
wherein the type of the non-3GPP access network provides direct internet protocol (IP) connection to the terminal without any intermediate network function.

17. The SMF of claim 16, wherein the first message is received based on a policy indicating which traffic is subject to the type of the non-3GPP access configured by policy control function (PCF).

18. The SMF of claim 16, wherein the information indicating whether the PDU session is for the type of the non-3GPP access comprises information indicating the PDU session is for a multi access (MA) PDU session.

19. The SMF of claim 16, wherein the information on the external proxy address comprises at least one of IP address or port number.

20. The SMF of claim 19,
wherein the controller is further configured to:
select the UPF supporting the type of the non-3GPP access, and
wherein the UPF is selected based on information retrieved from a network repository function (NRF).
